(19) United States
(12) Patent Application Publication
(10) Pub. No.: US 2026/0189960 A1
(43) Pub. Date: Jul. 2, 2026

(54) QUALITY OF EXPERIENCE AND RADIO ACCESS NETWORK VISIBLE QUALITY OF EXPERIENCE REPORTING UPON RADIO LINK FAILURES IN NEW RADIO DUAL CONNECTIVITY

(71) Applicant: Telefonaktiebolaget LM Ericsson (publ), Stockholm (SE)

(72) Inventors: Agne ÅBERG LARSSON, UPPSALA (SE); Filip BARAC, HUDDINGE (SE); Cecilia EKLÖF, TÄBY (SE); Luca LUNARDI, GENOVA (IT); Mattias BERGSTRÖM, SOLLENTUNA (SE); Vengatanathan KRISHNAMOORTHI, LINKÖPING (SE); Johan RUNE, LIDINGÖ (SE)

(21) Appl. No.: 19/130,135

(22) PCT Filed: Nov. 13, 2023
(86) PCT No.: PCT/SE2023/051147

§ 371 Date: May 15, 2025

Related U.S. Application Data
(60) Provisional application No. 63/425,634, filed on Nov. 15, 2022.

(51) Int. Cl. H04W 24/10; H04W 36/30

(52) U.S. Cl. CPC H04W 24/10; H04W 36/305

(57) ABSTRACT

A communication device can be in a communications network that includes a first network node and a second network node providing dual connectivity to the communication device. The communication device can determine a failure has occurred during transmission of a report to the first network node. The report can be a quality of experience, QoE, report and/or a radio access network visible QoE, RVQoE, report. The communication device can, responsive to determining that the failure has occurred, suspend transmission of the report to the first network node. The communication device can, responsive to determining that the failure has occurred, perform an action associated with the report.

### TECHNICAL FIELD

The present disclosure is related to wireless communication systems and more particularly to handling quality of experience (“QoE”) and radio access network visible QoE (“RVQoE”) reporting upon radio link failures in new radio dual connectivity (“NR-DC”).

### BACKGROUND

FIG. 1 illustrates an example of current 5^{th} generation radio access network (“NG-RAN”) architecture. The NG-RAN architecture can be further described as follows. The NG-RAN includes a set of 5^{th} generation (“5G”) base stations (referred to herein as gNBs) connected to the 5^{th} generation core network (“5GC”) through the next generation (“NG”) interface. A gNB can support frequency division duplex (“FDD”) mode, time division duplex (“TDD”) mode or dual mode operation. gNBs can be interconnected through the Xn-C interface. A gNB can include a gNB-central unit (“CU”) and gNB-distributed units (“DUs”). A gNB-CU and a gNB-DU are connected via a F1 logical interface. One gNB-DU is connected to only one gNB-CU. For resiliency, a gNB-DU may be connected to multiple gNB-CU by appropriate implementation. NG, Xn-C, and F1 are logical interfaces. The NG-RAN is layered into a Radio Network Layer (“RNL”) and a Transport Network Layer (“TNL”). The NG-RAN architecture (e.g., the NG-RAN logical nodes and interfaces between them) is defined as part of the RNL. For each NG-RAN interface (e.g., NG, Xn-C, and F1) the related TNL protocol and the functionality are specified. The TNL provides services for user plane transport and signaling transport.

For NG-RAN, the NG and Xn-C interfaces for a gNB consisting of a gNB-CU and gNB-DUs, terminate in the gNB-CU. For EN-DC, the S1-U and X2-C interfaces for a gNB including a gNB-CU and gNB-DUs, terminate in the gNB-CU. The gNB-CU and connected gNB-DUs are only visible to other gNBs and the 5GC as a gNB.

A gNB may also be connected to a long term evolution (“LTE”) base station (referred to herein as an eNB) via an X2 interface. Another architectural option is that where an LTE eNB connected to the Evolved Packet Core network is connected over the X2 interface with a so called nr-gNB. The latter is a gNB not connected directly to a core network (“CN”) and connected via X2 to an eNB for the sole purpose of performing dual connectivity.

The architecture in FIG. 1 can be expanded by splitting the gNB-CU into two entities: one gNB-CU-user plane (“UP”), which serves the user plane and hosts the packet data convergence protocol (“PDCP”) and one gNB-CU-control plane (“CP”), which serves the control plane and hosts the PDCP and radio resource control (“RRC”) protocol. A gNB-DU hosts the radio link control (“RLC”)/media access control (“MAC”)/physical layer (“PHY”) protocols.

Other standardization groups, such as the open radio access network (“ORAN”), have further extended the architecture above and have for example split the gNB-DU into two further nodes connected by a fronthaul interface. The lower node of the split gNB-DU can include the PHY protocol and the radio frequency (“RF”) parts, the upper node of the split gNB-DU can host the RLC and MAC. In ORAN the upper node is called O-DU, while the lower node is called O-RU.

An NG-RAN can also include a set of ng-eNBs, an ng-eNB can include an ng-eNB-CU and one or more ng-eNB-DU(s). An ng-eNB-CU and an ng-eNB-DU can be connected via a W1 interface. While this disclosure may refer generally to gNBs, the general principles may apply to other radio access technologies, for example, the principles may apply to a ng-eNB and W1 interface.

FIG. 2 illustrates an example of an architecture for separation of gNB-CU-CP and gNB-CU-UP. A gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. One gNB-DU is connected to only one gNB-CU-CP. One gNB-CU-UP is connected to only one gNB-CU-CP. One gNB-DU can be connected to multiple gNB-CU-UPs under the control of the same gNB-CU-CP. One gNB-CU-UP can be connected to multiple DUs under the control of the same gNB-CU-CP.

In dual connectivity a UE capable of multiple transmission/receptions, may be connected to more than one RAN node. The RAN nodes may be of the same RAT (both master node and secondary node in NR or LTE respectively) or different RATs, for example one master LTE node and one secondary NR node.

### SUMMARY

According to some embodiments, a method of operating a communication device in a communications network that includes a first network node and a second network node providing dual connectivity to the communication device is provided. The method includes determining a failure has occurred during transmission of a report to the first network node. The report includes a quality of experience (“QoE”) report and/or a radio access network visible QoE (“RVQoE”) report. The method further includes, responsive to determining that the failure has occurred, suspending transmission of the report to the first network node. The method further includes, responsive to determining that the failure has occurred, performing an action associated with the report.

According to other embodiments, a method of operating a first network node in a communications network that includes a second network node is provided. The first network node and the second network node provide dual connectivity to a communication device. The method includes determining a failure has occurred during transmission of a report from the communication device to the second network node. The report includes a quality of experience (“QoE”) report and/or a radio access network visible QoE (“RVQoE”) report. The method further includes, responsive to determining that the failure has occurred, communicating with the communication device.

According to other embodiments, a communication device, a first network node, a second network node, a computer program, a computer program product, a non-transitory computer readable medium, a host, or a system is provided to perform the above method.

Certain aspects of the disclosure and their embodiments may provide technical advantages. Some embodiments enable RVQoE and/or QoE reporting to continue in case of SCG failure, or MCG failure (e.g., in case a Fast MCG recovery procedure is used).

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a next generation radio access network (“NG-RAN”) overall architecture;

FIG. 2 is a schematic diagram illustrating an example of an overall architecture for separation of a gNB-central unit-control plane (“CU-CP”) and gNB-central unit-user plane (“CU-UP”);

FIG. 3 is a signal flow diagram illustrating an example of end-to-end signaling for configuration of QoE measurements;

FIG. 4 is a signal flow diagram illustrating an example of activation of signaling based QoE in NR;

FIG. 5 is a signal flow diagram illustrating an example of RRC configuration and reporting of QoE measurements;

FIG. 6 is a diagram illustrating an example of an ASN.1 code for a AppLayerMeasConfig information element;

FIG. 7 is a table illustrating an example of AppLayerMeasConfig field descriptions;

FIG. 8 is a table illustrating an example of RAN-VisibleParameters field descriptions;

FIG. 9 is a table illustrating an example of conditional presence associated with the AppLayerMeasConfig IE;

FIG. 10 is a diagram illustrating an example of an ASN.1 code for a MeasurementReportAppLayer message;

FIG. 11 is a table illustrating an example of MeasReportAppLayer field descriptions;

FIG. 12 is a table illustrating an example of RAN-VisibleMeasurements field descriptions;

FIG. 13 is a diagram illustrating an example of an ASN.1 code for a AppLayerMeasConfig IE in accordance with some embodiments;

FIG. 14 is a flow chart illustrating an example of operations performed by a communication device in accordance with some embodiments;

FIG. 15 is a flow chart illustrating an example of operations performed by a network node in accordance with some embodiments;

FIG. 16 is a block diagram of a communication system in accordance with some embodiments;

FIG. 17 is a block diagram of a user equipment in accordance with some embodiments;

FIG. 18 is a block diagram of a network node in accordance with some embodiments;

FIG. 19 is a block diagram of a host, which may be an embodiment of the host of FIG. 16, in accordance with some embodiments;

FIG. 20 is a block diagram of a virtualization environment in accordance with some embodiments; and

FIG. 21 shows a communication diagram of a host communicating via a network node with a user equipment over a partially wireless connection in accordance with some embodiments.

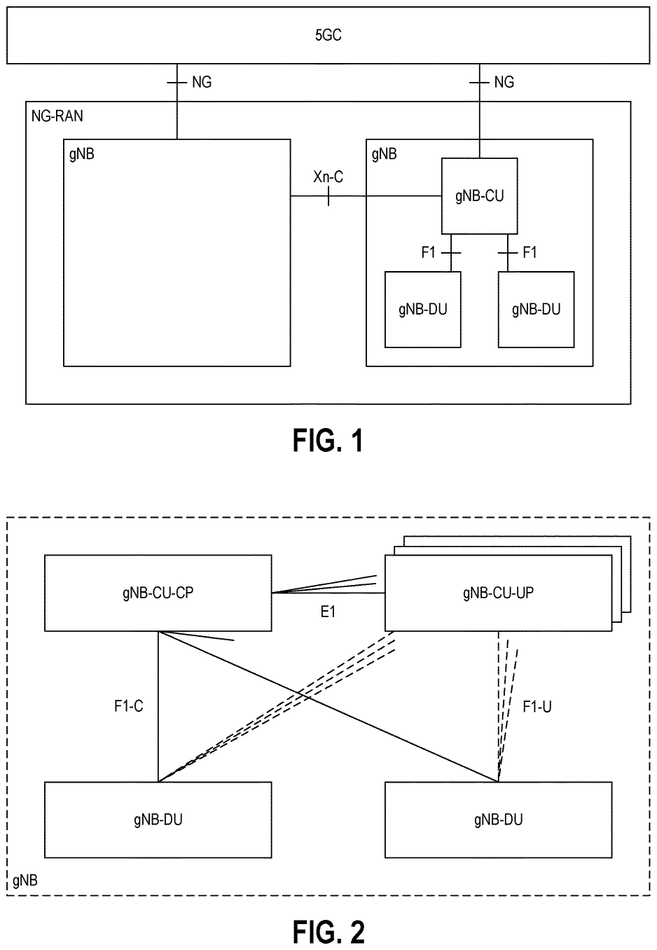

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

A Quality of Experience (“QoE”) framework is described below. QoE measurements (sometimes referred to as “application layer measurements”), have been specified for long term evolution (“LTE”) and universal mobile telecommunications system (“UMTS”) and are being specified for new radio (“NR”) in the third generation partnership project (“3GPP”) release 17. A purpose of the application layer measurements is to measure the end user experience when using certain applications. Currently QoE measurements for streaming services and for mobility telephony service for internet protocol multimedia subsystem (“MTSI”) services are supported. For NR, it is likely that at least virtual reality (“VR”) is added to the list of services for which QoE measurements are specified and supported.

The procedures for regular QoE are similar in NR, LTE, and UMTS with the overall principles as follows. Quality of Experience Measurement Collection (“QMC”) enables configuration of application layer measurements in the user equipment (“UE”) (also referred to as a communication device) and transmission of QoE measurement result files (commonly referred to as QoE reports) to the network by means of radio resource control (“RRC”) signaling. An application layer measurement configuration (also called QoE measurement configuration or QoE configuration) that the radio access network (“RAN”) receives from the operations, administration, and maintenance (“OAM”) system or the core network (“CN”) is encapsulated in a transparent container, which is forwarded to a UE in a downlink RRC message. An application layer measurement report (also called QoE report) that the UE Access Stratum (“AS”) or UE RRC layer receives from the UE's higher layer (application layer) is encapsulated in a transparent container and sent to network in an uplink RRC message. The RAN then forwards the QoE report to a Measurement Collector Entity (“MCE”).

The configuration data related to QoE measurements (in standard specifications typically referred to as application layer measurements) is received by the gNB from OAM and consists of a service type indication, an indication of an area in which the measurements are to be performed (denoted area scope), an internet protocol (“IP”) address of the entity the collected measurement results (e.g., the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” which the network entities handling it (e.g., forwarding it to the UE) as well as the UE Access Stratum cannot interpret and do not try to read.

The container is forwarded to the UE in RRC signaling together with the indicated service type. For measurements in RRC_CONNECTED, the area is kept in the gNB and the network ensures that the UE measures in the correct area by configuring the UE as to when to start and stop the measurements. The area scope is defined in terms of cells or network related areas. In UMTS, an area scope is defined as either a list of cells, a list of routing areas, or a list of tracking areas. In LTE and NR, an area scope is defined as either a list of cells or a list of tracking areas.

QoE, and in particular QoE configuration, comes in two types: management-based QoE configuration and signaling-based QoE configuration. In both cases the QoE configuration originates in the OAM system or some other administrational entity (e.g., dealing with customer satisfaction). Herein these entities are sometimes referred to as the OAM system (where the OAM system also includes further entities). With management-based QoE (sometimes referred to herein as m-based QoE), the OAM system is typically interested in general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (sometimes referred to herein as s-based QoE), the OAM system is interested in collecting QoE measurement results from a specific UE (e.g., because the user of the UE has filed a complaint). The OAM system sends the s-based QoE configuration to the home subscriber server (“HSS”) (in evolved packet system (“EPS”)/LTE) or unified data management (“UDM”) (in 5GS/NR), which forwards the QoE configuration to the UE's current core network node (e.g., an mobility management entity (“MME”) in EPS/LTE or an access and mobility management function (“AMF”) in 5G/NR). The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality is logically separated from the Trace functionality, but it will still partly reuse the Trace signaling mechanisms. In NR and LTE, a globally unique QoE reference (formed of mobile country codes (“MCC”)+mobile network codes (“MNC”)+QMC identifier (“ID”), where the QMC ID is a string of 24 bits) will be associated with each QoE configuration. The QoE reference is included in the container with measurement instructions and also sent to the RAN (e.g., the gNB in NR). For the communication between the gNB and the UE, the QoE reference is replaced by a shorter identifier denoted as measConfigAppLayerId, which is locally unique within a UE (e.g., there is a one-to-one mapping between a measConfigAppLayerId and a QoE reference for each QoE configuration provided to a UE. The measConfigAppLayerId is stored in the UE Access Stratum and also forwarded in an AT Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting (e.g., in case the cell/gNB is in a state of overload).

The RAN is not aware of when an application session with an associated QoE measurement session is ongoing and the UE Access Stratum is also not automatically aware of this. To alleviate this session start/stop indications has been introduced, which are sent from the application layer in the UE to the UE AS and from the UE AS to the RAN. A session end indication are sent when the application session and the associated QoE measurement session are concluded.

The RAN may decide to release a QoE configuration in a UE at any time, as an implementation-based decision. Typically, it is done when the UE has moved outside an area configured for the QoE measurements (commonly referred to as the area scope) and the measurement session has ended.

An extension of the QoE framework which has been implemented in 3GPP release 17 is the concept of RAN visible QoE (“RVQoE”). The regular QoE reports are intended for the MCE, which is an entity outside the RAN (e.g., a part of the OAM system) and the RAN cannot read the QoE reports (at least not according to specification although gNB/eNB implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

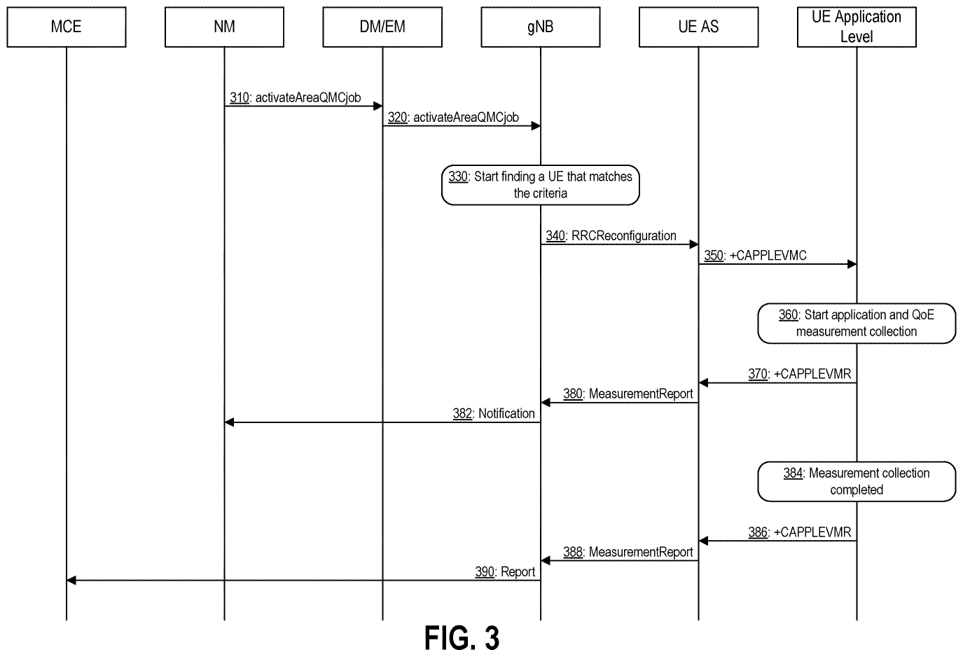

The end-do-end signaling for configuration of QoE measurements are illustrated in FIG. 3. At operation 310, the NM transmits an activateAreaQMCjob message to the DM/EM. In some examples, the activateAreaQMCjob message includes a service type, area scope, slice scope, QoE CE Address, PLMN target, QoE target, QoE reference, and/or QMC configuration file. At operation 320, the DM/EM forwards the activateAreaQMC job message to the gNB. At operation 330, the gNB starts finding a UE that matches the criteria. At operation 340, the gNB transmits a RRCReconfiguration message to the UE AS. At operation 350, the UE AS transmits a +CAPPLEVMC message to the UE Application level. In some examples, the RRCReconfiguration message and the +CAPPLEVMC message include information from the activateAreaQMCjob message.

At operation 360, the UE Application Level starts application and QoE measurement collection. At operation 370, the UE Application Level transmits a +CAPPLEVMR message to the UE AS. At operation 380, the UE AS transmits a MeasurementReport to the gNB. In some examples, the +CAPPLEVMR message and the MeasurementReport include a MeasConfigAppLayerId. At operation 382, the gNB transmits a notification to the NM. In some examples, the notification includes an indication of a recording session.

At operation 384, the UE Application Level measurement collection is completed. At operation 386, the UE Application Level transmits a +CAPPLEVMR message to the UE AS. At operation 388, the UE AS transmits a MeasurementReport message to the gNB. In some examples, the +CAPPLEVMR message and the MeasurementReport message include information associated with the measurements collected by the UE Application Level. At operation 390, the gNB transmits a report to the MCE.

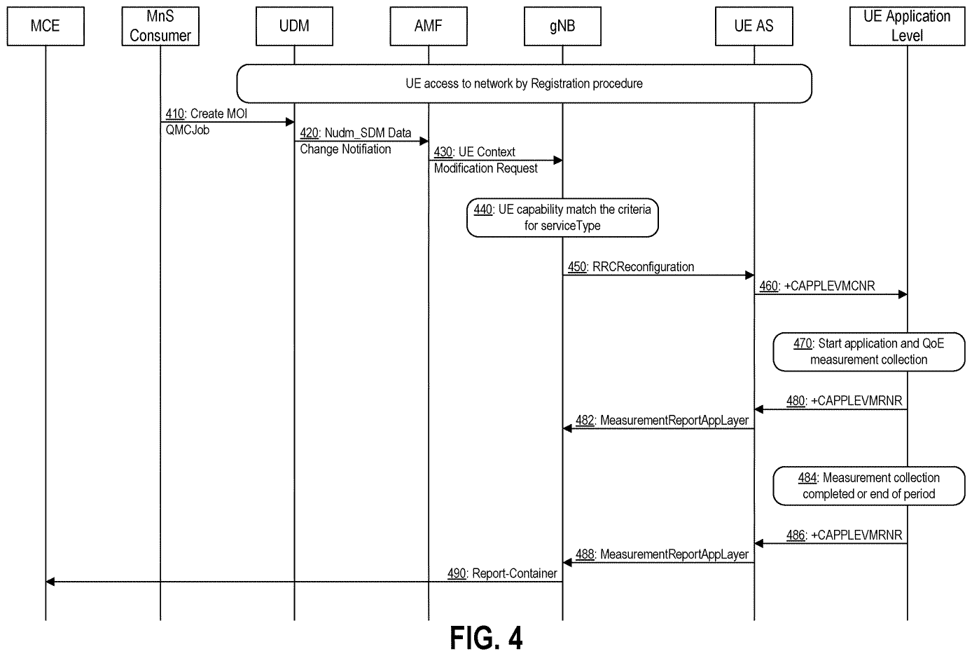

The activation of signaling based QoE in NR is illustrated in FIG. 4. First, a UE may gain access to a network by a registration procedure. Then, at operation 410, a MnS consumer transmits a message to create a MOI QMC job to a UDM. The UDM can transmit a Nudm_SDM Data Change Notification to an AMF based on the information in the message from the MnS consumer (operation 420). At operation 430, the AMF transmits a UE Context Modification Request to a gNB. The gNB verifies that the UE capabilities match the criteria for a service type indicated in the UE Context Modification Request (operation 440). At operation 450, the gNB transmits a RRCReconfiguration message to a UE AS. At operation 460, the UE AS transmits a +CAPPLEVMCNR to the UE Application Level.

At operation 470, the UE Application Level starts application and QoE measurement collection. At operation 480, the UE Application Level transmits a +CAPPLEVMRNR message to the UE AS. At operation 482, the UE AS transmits a MeasurementReprotAppLayer message to the gNB.

At operation 484, the UE Application Level measurement collection is completed. At operation 486, the UE Application Level transmits a +CAPPLEVMRNR to the UE AS. At operation 488, the UE AS transmits a MeausmentReprotAppLayer message to the gNB. At operation 490, the gNB transmits a Report-Container to the MCE.

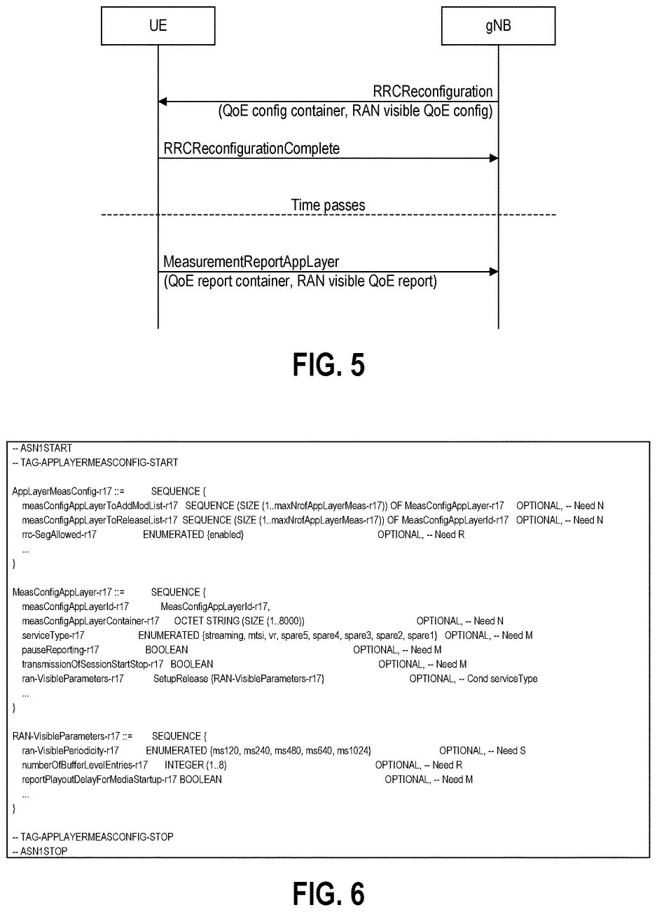

Configuration and reporting of QoE and RVQoE measurements in RRC are described below. The configuration of QoE and RVQoE measurements is done by the RRC message RRCReconfiguration and the reports are sent in the RRC message MeasurementReportAppLayer according to the signal flow illustrated in FIG. 5.

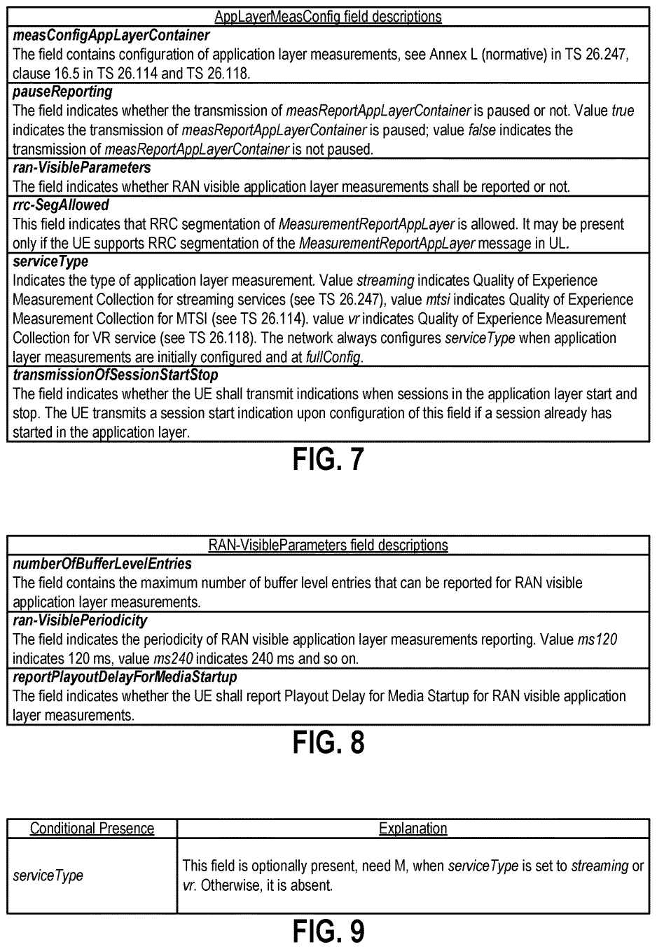

FIG. 5 illustrates an example of RRC configuration and reporting of QoE measurements. As illustrated, the gNB transmits a RRCReconfiguration message to the UE. The RRCReconfiguration message can include the information element AppLayerMeasConfig. In some examples, the RRCReconfiation message and/or the AppLayerMeasConfig IE includes either a configuration container for configuration of regular QoE or RRC parameters for configuration of RVQoE. FIG. 6 illustrates an example of an ASN.1 code for the AppLayerMeasConfig IE that indicates configuration of application layer measurements. FIG. 7 illustrates an example of descriptions of the fields in the AppLayerMeasConfig IE. The AppLayerMeasConfig fields can include: measConfigAppLayerContainer; pauseReporting; ran-VisibleParameters; rrc-SegAllowed; serviceType; and transmissionOfSessionStartStop. FIG. 8 illustrates an example of description of fields in the RAN-VisibleParameters field of the AppLayerMeasConfig IE. The RAN-VisibleParameters fields can include: numberOfBufferLevelEntires (e.g., including a maximum number of buffer level entries that can be reported for RAN visible application layer measurements); ran-VisiblePeriodicity (e.g., indicating the periodicity of RAN visible application layer measurements reporting); and reportPlayoutDelay ForMediaStartup (e.g., indicating whether the UE shall report Playout Delay for Media Startup for RAN visible application layer measurements). FIG. 9 illustrates an example of a conditional presence associated with the AppLayerMeasConfig IE.

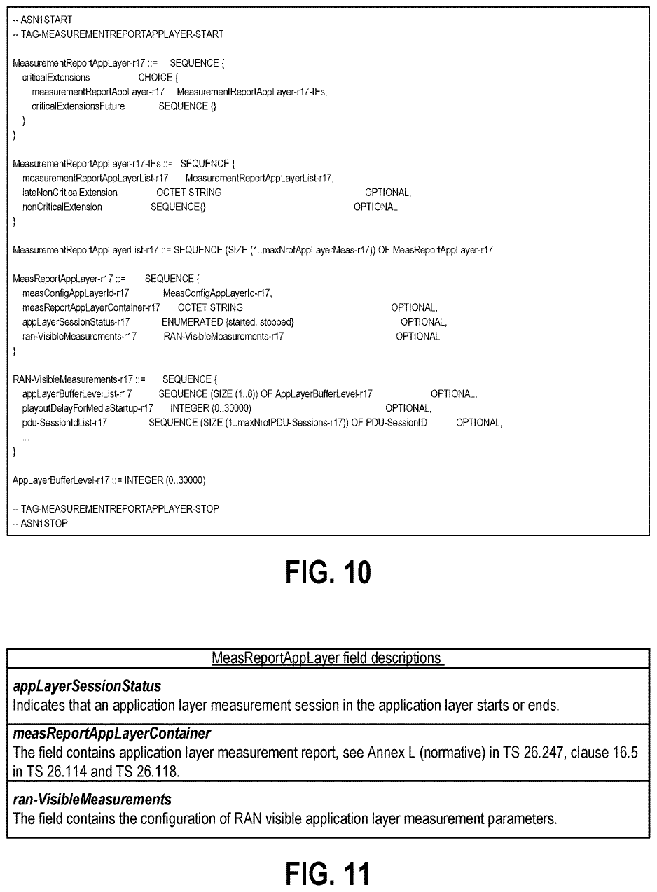

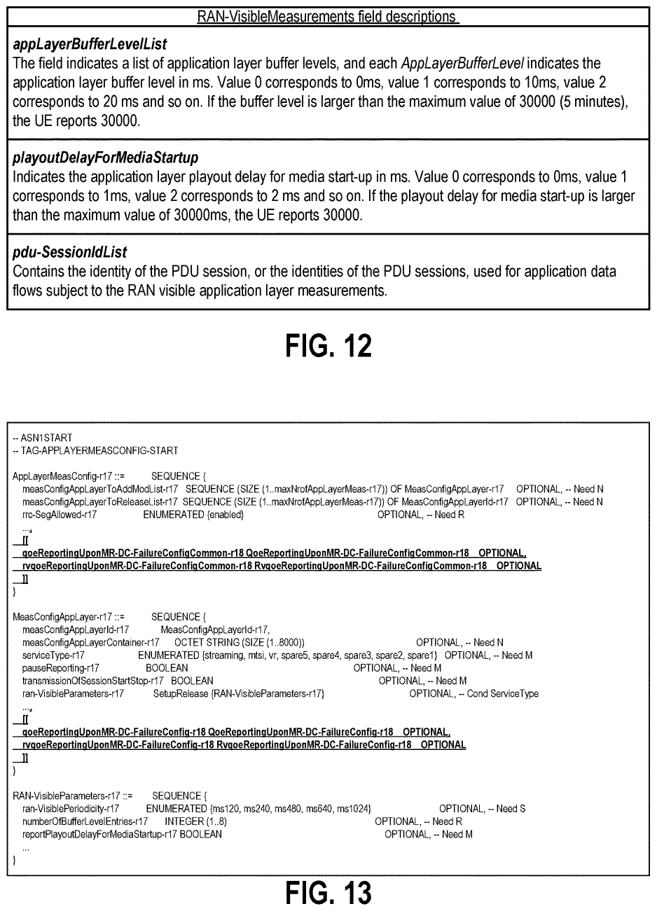

Returning to FIG. 5, the UE can respond by transmitting a RRCReconfigurationComplete message to the gNB. After some time passes, the UE can further transmit a MeasurementReportAppLayer message to the gNB. In some examples, the MeasurementReportAppLayer includes a AppLayerMeasConfig IE. FIG. 10 illustrates an example of an ASN.1 code for a MeasurementReportAppLayer IE that includes either a report container for regular QoE and/or RRC parameters for report of RVQoE. The MeasurementReportAppLayer message is used for sending application layer measurement report. FIG. 11 illustrates an example of a MeasReportAppLayer field description. The MeasReprotAppLayer fields include: appLayerSessionSatus; measReportAppLayerContainer; and ran-VisibleMeasurements. FIG. 12 illustrates an example of a RAN-VisibleMeasurements field description. The RAN-VisibleMeasurements fields can include appLayerBufferLevelList (e.g., indicating a list of application layer buffer levels); playoutDelayForMediaSartup (e.g., indicating the application layer playout delay for media start-up); and pdu-SessionIdList (e.g., including an identity of the PDU session).

In existing specifications, the network can only configure RVQoE if there also is a corresponding configuration of regular QoE in the UE. Further description of FIGS. 6-12 can be found in TS 38.331 v 17.2.0.

AT commands are used for communication between the AS (radio) layer and the application layer in the UE. The AT commands are used in QoE for transferring of the configuration from the RRC layer to the application and for transferring of reports from the application layer to the RRC layer.

In 3GPP Rel-12, the LTE feature Dual Connectivity (“DC”) was introduced, to enable the UE to be connected in two cell groups, each controlled by an LTE access node, eNBs, labelled as the Master eNB, MeNB and the Secondary eNB, SeNB. The UE only has one RRC connection with the network. In 3GPP, the DC solution has since then been evolved and is now also specified for NR as well as between LTE and NR. Multi-connectivity (“MC”) is the case when there are more than 2 nodes involved. With introduction of 5G, the term MR-DC (Multi-Radio Dual Connectivity) was defined as a generic term for all dual connectivity options which includes at least one NR access node. Using the MR-DC generalized terminology, the UE is connected in a Master Cell Group (“MCG”), controlled by the Master Node (“MN”), and in a Secondary Cell Group (“SCG”) controlled by a Secondary Node (“SN”).

Further, in MR-DC, when dual connectivity is configured for the UE, within each of the two cell groups, MCG and SCG, carrier aggregation may be used as well. In this case, within the Master Cell Group, MCG, controlled by the MN, the UE may use one PCell and one or more SCell(s). And within the Secondary Cell Group, SCG, controlled by the secondary node (SN), the UE may use one Primary SCell (PSCell, also known as the primary SCG cell in NR) and one or more SCell(s). In NR, the primary cell of a master or secondary cell group is sometimes also referred to as the Special Cell (SpCell). Hence, the SpCell in the MCG is the PCell and the SpCell in the SCG is the PSCell.

The UE triggers SCG failure in the following cases: SCG RLF, SCG beam failure while SCG is deactivated, SN addition/change failure, SCG configuration failure for RRC message on SRB3, failure of SCG reconfiguration with sync, SCG integrity check failure, etc. The UE indicates the SCG failure to the gNB by transmitting the RRC message SCGFailureInformation.

The UE triggers fast MCG link recovery, if radio link failure is detected for MCG link, fast MCG link recovery is configured, and the SCG is not deactivated. Otherwise, the UE initiates the RRC connection re-establishment procedure. Similarly, the UE initiates the RRC connection re-establishment procedure upon PSCell addition or PSCell change, if MCG link failure is detected.

During fast MCG link recovery, the UE suspends MCG transmissions for all radio bearers except for SRB, and if any, BH RLC channels and reports the failure with MCGFailureInformation message to the MN via the SCG, using the SCG leg of split SRB1 or SRB3. The UE includes in the MCGFailureInformation message the measurement results available according to current measurement configuration of both the MN and SN.

There currently exist certain challenges. Currently there is no support in the 3GPP specifications for QoE measurement configuration and reporting in Dual Connectivity. Current specifications consider only a case when a UE is connected to a single gNB which both provides the QoE configuration and receives the resulting reports. One of the aims for the release 18 is to enhance support for QoE in the dual connectivity scenario. While work has already been started on discussions of which node should be allowed to configure the UE for QoE measurements and which bearers should be used both for the configuration and the reporting of the QoE, some fundamental issues arising from the use of NR-DC have not been addressed. Namely, radio link failures and changes in the SN/SCG upon mobility or SN handover.

Certain aspects of the disclosure and their embodiments may provide solutions to these or other challenges. Various embodiments provide procedures for treatment of QoE and RVQoE reporting and reporting continuation in case that the RLF occurs in NR-DC. The solution involves actions to be performed by the UE for QoE/RVQoE measurement and reporting when radio failures in one of the two cell groups is detected. The UE actions may be exchanged a priori, requested/on-demand (where the failure cause may also be communicated as part of the QoE reporting) or on interpreted basis. Special cases such as failure on both legs are also addressed.

In some embodiments, procedures are provided for handling transmission of QoE/RVQoE reports in NR-DC scenario when there is a failure in one of the nodes, Master Node or Secondary Node.

Various embodiments are associated with QoE report transmission handling upon radio link failures. Some embodiments associated with QoE report handling upon changes in the SN are described below.

In some embodiments, the SN may be activated as a secondary source to provide additional resources to improve user experience and hence also carries the application session's data flow(s), alone, or in addition to the MN. In this case, SN could also configure a UE for the QoE/RVQoE measurements. However, the following applies for the case, when the MN is the main carrier of the application session data flow(s) and if the session is uninterrupted (at least from the MN side).

In some embodiments in which a UE is sending the QoE and/or RVQoE reports to the SN, and the SCG failure takes place, but there is no MCG failure detected, the UE may record and indicate the SCG failure in a QoE report and/or a RVQoE report (preferably a report covering the time period during which the SCG failure occurred), e.g. by sending an indication of the SCG failure that occurred together with the QoE report and/or the reported RVQoE metrics in the MeasurementReportAppLayer RRC message. In some examples, this may be recorded if the UE is configured with RAN located QoE measurements, i.e. QoE measurements performed in the AS layer in the UE. In additional or alternative examples, if the UE is not configured with RAN located QoE measurements, an indication of SCG failure may be added in AT-command(s). In additional or alternative examples, together with the SCG failure indication included in the QoE report and/or RVQoE report, the UE may include information about the SCG failure, e.g. the elapsed time (duration) between the SCG failure and successful recovery. This may be indicated e.g. in the form of timestamps for the failure and the successful recovery, or in the form of an indication of the duration e.g. in milliseconds. In additional or alternative examples, when the UE AS receives the RVQoE report from the UE application layer, the UE AS may add the SCG failure indication (and optionally associated information) to the RVQoE report before storing it or forwarding it to the RAN, or complement the received RVQoE report parameters with the SCG failure indication (and optionally associated information) before storing the RVQoE report parameters and the SCG failure indication or forwarding them to the RAN.

In additional or alternative embodiments, the UE may stop reporting QoE/RVQoE measurements altogether and store the QoE/RVQoE reports instead if/while the UE attempts to re-establish the SCG connection. In some examples, QoE/RVQoE Reports may be discarded if the connection re-establishment fails, or if some time limit is exceeded. In additional or alternative examples, the UE may instead start sending the QoE and/or RVQoE reports to the MN/MCG, while/if it attempts to initiate the connection re-establishment procedure to the SCG. The decision to start sending the reports to the MN may be taken in one of the following ways: the UE may on its own start sending the reports to the MN (i.e., without being instructed), the UE may receive such an indication from the MN, or the UE may inquire the MN about how to proceed with reporting. In additional or alternative examples, prior to the SCG failure detection, for example at the time of SN Addition or SN Modification, the UE may have received an explicit indication (either from the MN or the SN) that in case of SCG Failure, the reporting leg (i.e. the DC connectivity leg to send reports on) to be used for QoE/RVQoE reporting will have to be switched, or, that in case of SCG failure, the QoE/RVQoE reporting will have to be paused/stopped. The UE may be configured with an indication to continue the QoE measurements, but to pause the reporting until the SCG has recovered. The UE may be configured with an indication to pause both the measurements and the reporting until the SCG has recovered. The indications may be separate for QoE and RVQoE, so that e.g. QoE measurements continue but the reporting is paused, but the RVQoE measurements are paused as well as the reporting.

The innovations described herein may be applied to UE behavior upon SCG failure. In additional or alternative embodiments, this may require that a UE is reconfigured with another SRB for delivering the reports to the network.

In additional or alternative embodiments, as soon as the SN detects the SCG failure, the SN may inquire the MN to instruct the UE to send the reports to the MN from now on. In another variant, as mentioned above, the UE may inquire the MN about how to proceed with reporting. In some examples, the instruction to the UE to send the reports to MN from now on may apply to either QoE or RVQoE reports or both. It can also apply per QoE/RVQoE configuration or to all QoE/RVQoE configurations or only to QoE or only to RVQoE configurations. In additional or alternative examples, before the failure, the SN was forwarding the QoE reports directly to the MCE, if the MN is about to start receiving the reports, the MN may need to request from the SN the information needed for forwarding the reports to the correct MCE, such as the MCE IP address, the URI, the mapping between the measConfigAppLayerId and QoE reference (in case it does not have this info already). In another variant, the info is provided from the SN, as soon as the SCG failure is detected.

Upon successful SCG re-establishment, the SN or the MN may send an indication to the UE (after coordination) to resume sending the reports to the SN.

The above options and procedural extensions also apply to the case where an attempted SN change results in SN addition failure. The UE might be instructed to continue QoE/RVQoE measurements, but pause reporting, or continue reporting to either the MN or the SN during the SN change phase. Upon detection of SN addition failure, the UE may inquire the MN about how to proceed with reporting or the UE may have received an indication as described above.

Some embodiments associated with QoE report handling upon failures in the MN are described below. In some embodiments in which a UE is sending the QoE and/or RVQoE reports to the MN, and the MCG failure takes place, but there is no SCG failure, the UE may record and indicate the MCG failure in a QoE report and/or a RVQoE report, (preferably a report covering the time period during which the MCG failure occurred), e.g. by sending an indication of the MCG failure that occurred together with the QoE repot and/or the reported RVQoE metrics in the MeasurementReportAppLayer RRC message.

In some examples, this may be recorded if the UE is configured with RAN located QoE measurements. In additional or alternative examples, if the UE is not configured with RAN located QoE measurements, an indication of MCG failure may be added in AT-command(s). In additional or alternative examples, together with the MCG failure indication included in the QoE report and/or RVQoE report, the UE may include information about the MCG failure (e.g., the elapsed time (duration) between the MCG failure and successful recovery). This may be indicated e.g. in the form of timestamps for the failure and the successful recovery, or in the form of an indication of the duration e.g. in milliseconds. In additional or alternative examples, for RVQoE reports, when the UE AS receives the RVQoE report from the UE application layer, the UE AS may add the MCG failure indication (and optionally associated information) to the RVQoE report before storing it or forwarding it to the RAN, or complement the received RVQoE report parameters with the MCG failure indication (and optionally associated information) before storing the RVQoE report parameters and the MCG failure indication or forwarding them to the RAN.

In additional or alternative embodiments, the UE may stop reporting QoE/RVQoE measurements and store the QoE/RVQoE reports if/while a UE attempts to re-establish the MCG connection.

In additional or alternative embodiments, reports may be discarded if the re-connection establishment fails or if some time limit is exceeded (e.g., some timer expires).

In additional or alternative embodiments, the UE may be configured with an indication in advance related to the behaviour in case of MCG failure. In some examples, the indication can e.g. indicated that the QoE and/or the RVQoE reports.

In additional or alternative embodiments, the UE may receive the indication from the SN to start sending the reports to the SCG, while it (i.e., UE) simultaneously initiates the RRC connection re-establishment procedure to MCG.

The innovations described herein may be applied to UE behavior upon MCG failure. In additional or alternative embodiments, upon successful re-establishment procedure, the UE may resume sending the QoE and/or RVQoE reports to the MCG, if it receives any such indication from the MN.

The above options and procedural extensions may also apply to the case of an attempted MN change that results in a failure case that triggers a fast MCG link recovery.

Some embodiments associated with QoE reporting handling upon failures in the MN and the SN are described below. In some embodiments in which both MCG and SCG fails, the UE may store the reports until the connection is re-established to either of the nodes. The restored node may inform the UE that it should send the stored reports/resume sending the reports to that recovered node. There could be different conditions for storing QoE and RVQoE reports as they serve different purposes. The UE may be configured by the network regarding what actions to take or the actions may be decided by the UE (based on UE implementation). The actions could, for example, be to continue the measurements and store the reports until one or both nodes are resumed or e.g. to continue the QoE measurements but not the RVQoE measurements until one or both nodes are resumed.

Some embodiments associated with QoE reporting handling in case of Fast MCG link recovery are described below. In some embodiments, fast MCG link recovery is an RRC procedure applicable to UEs in MR-DC, where the UE sends an MCG Failure Information message to the MN via the SCG upon the detection of a radio link failure on the MCG.

In some embodiments in which a UE is sending the QoE and/or RVQoE reports to the MN, MCG failure takes place, SCG link is not suspended and a Fast MCG link recovery is attempted, the UE may record and indicate the MCG failure in a QoE report and/or a RVQoE report (preferably a report covering the time period during which the MCG failure occurred), for example, by sending an indication of the MCG failure that occurred together with the QoE repot and/or the reported RVQoE metrics in the MeasurementReportAppLayer RRC message.

In some examples, this may be recorded if the UE is configured with RAN located QoE measurements.

In additional or alternative examples, if the UE is not configured with RAN located QoE measurements, an indication of MCG failure may be added in AT-command(s).

In additional or alternative examples, together with the MCG failure indication included in the QoE report and/or RVQoE report, the UE may include information about the MCG failure, e.g. the elapsed time (duration) between the MCG failure and successful recovery. This may be indicated e.g. in the form of timestamps for the failure and the successful recovery, or in the form of an indication of the duration (e.g., in milliseconds).

In additional or alternative examples, for RVQoE reports, when the UE AS receives the RVQoE report from the UE application layer, the UE AS may add the MCG failure indication (and optionally associated information) to the RVQoE report before storing it or forwarding it to the RAN, or complement the received RVQoE report parameters with the MCG failure indication (and optionally associated information) before storing the RVQoE report parameters and the MCG failure indication or forwarding them to the RAN.

In additional or alternative embodiments, the UE may stop reporting QoE/RVQoE measurements and store the QoE/RVQoE reports while Fast MCG link recovery is attempted.

In additional or alternative embodiments, the reports may be discarded if the re-connection establishment fails or if some time limit is exceeded (e.g., some timer expires).

In additional or alternative embodiments, the UE may receive the indication from the SN to start sending the reports to the SCG, while it (i.e., UE) simultaneously initiates the RRC connection re-establishment procedure to MCG.

In additional or alternative embodiments, upon successful MCG re-establishment procedure, the UE may resume sending the QoE and/or RVQoE reports to the MCG, if it receives any such indication from the MN.

When UE triggers an MCG Failure information to be sent to the MN via the SN, it starts a timer T316 during which the UE waits for instructions from MN. In case of successful recovery from MCG Failure, the value of the time elapsed since the start of T316 can be added to the QoE/RVQoE report. This would let the receiver of the report know that MCG Failure has occurred (potentially impacting the QoE for the users) and how long it took to recover such failure.

Similar to the above, if the UE is sending the QoE and/or RVQoE reports to the SN when MCG failure takes place, Fast MCG link recovery is attempted and the same steps as described above can take place. In a variation of this, upon attempting to recover the MCG link via Fast MCG link recovery, the SN can send an indication to the UE to pause QoE/RVQoE reports until/if the MCG link is recovered. During the MCG recovery procedure, the SN can notify to the MN in a XnAP message (e.g. in an XnAP RRC TRANSFER message, as part of, or together with the Fast MCG Recovery via SRB3 from SN to MN IE containing the RRC Container within which the MCGFailureInformation IE is provided) that QoE/RVQoE reporting for the UE has been paused/stopped.

At successful completion of the MCG Failure recovery, the MN can send to the UE, via the MN an indication that QoE/RVQoE reporting is resumed/(re)started. The indication can be carried, for instance, together with or as part of the Fast MCG Recovery via SRB3 from MN to SN IE sent from MN to SN in an XnAP RRC TRANSFER message.

Some embodiments associated with reconfiguration failure on secondary node SRB are described below. In some embodiments, the UE will determine whether it can comply with an RRC message carrying QoE measurement related configurations from the SN. If the UE is not capable of complying with such a message, the UE would, upon attempting to apply the message, trigger a failure. This failure may be an SCG failure event.

In additional or alternative embodiments, the SCG failure event may be indicated in a message sent to another node than the SN itself, e.g. the MN. For example, in an SCGFailureInformation message.

In additional or alternative embodiments, the failure message may carry an indication indicating that the reason for the failure is that the UE has attempted to apply a reconfiguration message carrying QoE measurement related configurations. Although some embodiments herein describe that there is a message carrying QoE measurement related configurations, it should be appreciated that other indications/configurations may be carried in the same message (e.g., not directly related to QoE measurement configurations).

In additional or alternative embodiments, another approach is that the UE indicates on which bearer the message was received. Consider for example that the configuration message is sent on an SRB3, the UE may indicate that the UE has failed to comply to an RRC message received on SRB3. Note: When it here is described that there is a bearer that the is used to carry messages comprising QoE measurement related configurations, it should be appreciated that this bearer could be used to also carry other indications/configurations (i.e. not directly related to QoE measurement configurations). Hence, if the failure indication message only indicates that it was an SRB3 message that caused the failure, it may (from the failure message itself) not be known what configuration was carried in the message.

As previously mentioned, the UE's QoE and RVQoE reporting behavior in case of MCG and/or SCG failure may be either standardized or (pre)configured. If configuring is introduced, there are several degrees of freedom to explore, some of which are elaborated below.

In general, the UE may be configured to perform any of the following non-limiting list of actions upon MCG and/or SCG failure, wherein these actions may be configured differently depending on the failure type, e.g. MCG failure or SCG failure. Note that not all actions can be configured for all types of failure, and also note that more than one action may be configured and performed.

In some examples, the UE may be configured to send reports to the node for which failure has not occurred (e.g. send reports in that node's serving cell group, i.e. MCG or SCG).

In additional or alternative examples, the UE may be configured to store reports in the UE until successful recovery has been performed after the failure and then send the stored reports. This may advantageously be combined with configuration(s) of where to send the QoE and/or RVQoE reports.

In additional or alternative examples, the UE may be configured to start a timer at Tₘₐₓ₋ₛₜₒᵣₑ and store pending and newly generated reports in the UE. Upon successful failure recovery or upon expiration of Tₘₐₓ₋ₛₜₒᵣₑ, send the stored reports. (This may advantageously be combined with configuration(s) of where to send the QoE and/or RVQoE reports.)

In additional or alternative examples, the UE may be configured to if reporting is redirected to another node, keep reporting to this node even after successful failure recovery.

In additional or alternative examples, the UE may be configured to, if reporting is redirected to another node, go back to reporting to the original node after successful failure recovery.

In additional or alternative examples, the UE may be configured to start a timer at Tₘₐₓ₋ₛₜₒᵣₑ and store pending and newly generated reports in the UE. Upon successful failure recovery, send the stored reports (and stop the Tₘₐₓ₋ₛₜₒᵣₑ timer). Upon expiration of Tₘₐₓ₋ₛₜₒᵣₑ, discard stored reports. (This may advantageously be combined with configuration(s) of where to send the QoE and/or RVQoE reports.)

In additional or alternative examples, the UE may be configured to, if pending RVQoE reports are stored (e.g. according to one of the configuration options in this list), and more than one periodic RVQoE report is stored for the same application session, discard all but the latest generated RVQoE report.

In additional or alternative examples, the UE may be configured to, if pending RVQoE reports are stored (e.g. according to one of the configuration options in this list), discard any stored RVQoE report when it has been stored for a duration exceeding T_{max-store-individual-RVQoE-report} (which is a timer that may be started for each newly generated and stored RVQoE report).

In additional or alternative examples, the UE may be configured to, if pending RVQoE reports are stored (e.g. according to one of the configuration options in this list), discard a stored periodic RVQoE report when a subsequent periodic RVQoE report is generated for the same application session.

In additional or alternative examples, the UE may be configured to, if reporting is redirected to another node, encapsulate the MeasurementReportAppLayer RRC message in an ULInformation TransferMRDC RRC message. If this is configured only for one report type, i.e. only for one of QoE reports and RVQoE reports, the encapsulated MeasurementReportAppLayer RRC message should only contain report information pertaining to the concerned report type.

In additional or alternative examples, the UE may be configured to, if reporting is redirected from the SN (e.g., in the SCG) to the MN (e.g., in the MCG), encapsulate the MeasurementReportAppLayer RRC message in an ULInformationTransferMRDC RRC message. If this is configured only for one report type, i.e. only for one of QoE reports and RVQoE reports, the encapsulated MeasurementReportAppLayer RRC message should only contain report information pertaining to the concerned report type.

Each of the above may be configured separately for QoE reports and RVQoE reports, e.g. so that different actions are performed for the respective report types (and note that this includes that different timer values, e.g. different values of Tₘₐₓ₋ₛₜₒᵣₑ, may be configured for pending QoE reports and pending RVQoE reports), or commonly for both types of reports.

Different configurations may be associated with different failure types (e.g., MCG failure (general), SCG failure (general), RLF (in either MCG or SCG), beam failure (in either MCG or SCG), random access failure (in either MCG or SCG), consistent LBT failure (in either MCG or SCG), RLF in MCG, RLF in SCG, beam failure in MCG, beam failure in SCG, random access failure in MCG, random access failure in SCG, consistent LBT failure in MCG, and consistent LBT failure in SCG).

Furthermore, a configuration of the UE's reporting behavior upon failure while in MR-DC mode may have different scopes, e.g. applying to all configured QoE measurements and/or RVQoE measurements in the UE, applying to all configured QoE measurements and/or RVQoE measurements pertaining to a certain service type or certain service types in the UE, or applying to only one QoE configuration and/or RVQoE configuration.

The configuration of a UE's QoE/RVQoE reporting behavior upon failure while in MR-DC mode may advantageously be included in the AppLayerMeasConfig-r17 IE, inside or outside the MeasConfigAppLayer-r17 IE, in the RRCReconfiguration RRC message.

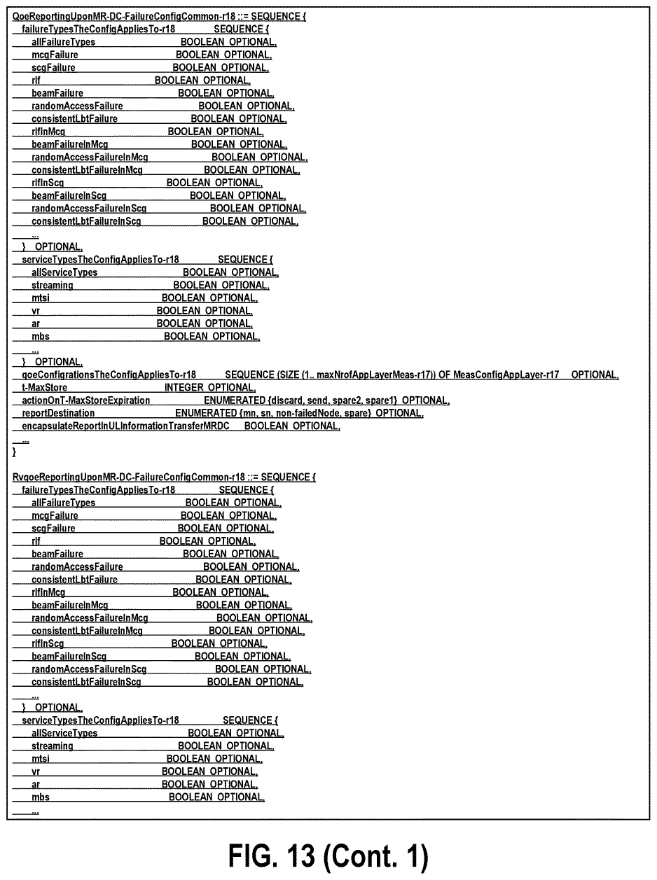

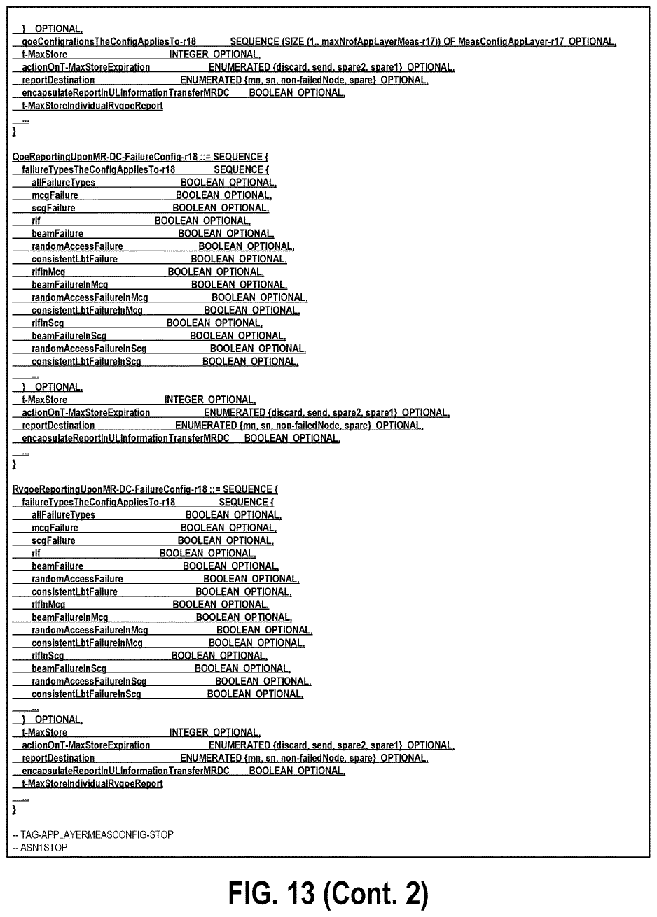

FIG. 13 illustrates an example of how the configuration options could be implemented in ASN.1 code in a future version of 3GPP. The example does not cover all the above described configuration options, but rather a selected few, in order to illustrate how this could be captured in ASN.1 code. It is based on the ASN.1 code for the AppLayerMeasConfig-r17 IE in 3GPP. The additions are bolded and underlined.

Another QoE related feature for which the UE's behavior in conjunction with failure in MR-DC mode is of interest to configure is the sending of session start indications and session stop indications. Like QoE reports and RVQoE reports, session start indications and session stop indications are sent from the UE to the RAN in MeasurementReportAppLayer RRC messages. Hence, similar configuration options as described above for QoE reporting and/or RVQoE reporting may be used for the UE's sending of session start indications and session stop indications too.

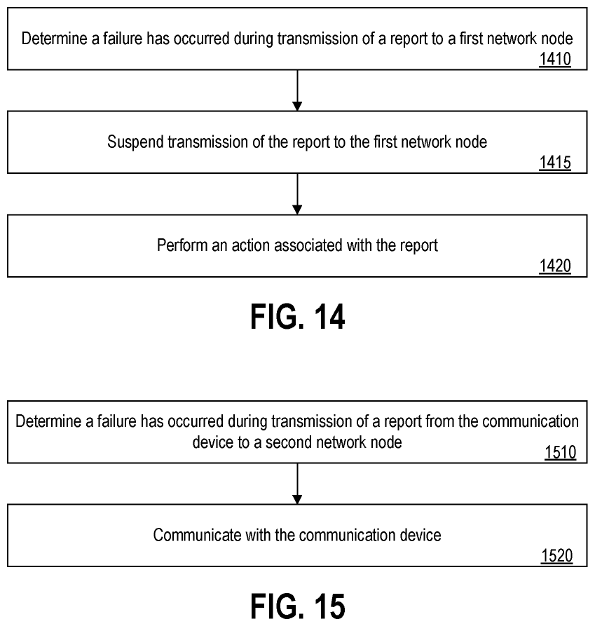

FIG. 14 illustrates an example of operations performed by a communication device in a communications network that includes a first network node and a second network node providing dual connectivity to the communication device.

At block 1410, the operations include determining a failure has occurred during transmission of a report to a first network node. In some embodiments, the report includes at least one of: a quality of experience, QoE, report; and a radio access network visible QoE, RVQoE, report.

In additional or alternative embodiments, the first network node is a master node, MN, the failure is a master cell group, MCG, failure, and the second network node is a secondary node, SN.

In additional or alternative embodiments, the first network node is a secondary node, SN, the failure is a secondary cell group, SCG, failure, and the second network node is a master node, MN.

At block 1415, the operations including suspending transmission of the report to the first network node. In some examples, suspending the transmission of the report to the first network node includes stopping, delaying, or postponing the transmission of the report to the first network node.

At block 1420, the operations include performing an action associated with the report. In some embodiments, performing the action includes transmitting the report to the second network node. In some examples, transmitting the report to the second network node includes receiving a message from the second network node, the message including a request for the report; and responsive to receiving the message, transmitting the report to the second network node. In additional or alternative examples, the message is a second message. Transmitting the report to the second network node further includes transmitting a first message to the second network node, the first message requesting instructions on how to handle the report.

In additional or alternative embodiments, performing the action includes, subsequent to determining the failure has occurred, initiating a timer.

In additional or alternative embodiments, performing the action includes storing the report and/or an indication of the failure in a local memory. In some examples, performing the action further includes, responsive to expiration of the timer, deleting the report and/or the indication of the failure from the local memory. In additional or alternative examples, storing the report and/or the indication of the failure in the local memory includes: determining that a communication failure has occurred with the second network node; and responsive to determining that the communication failure has occurred with the second network node, storing the report and/or the indication of the failure in the local memory.

In additional or alternative embodiments, performing the action further includes reconfiguring the communication device with another signaling radio bearer.

In additional or alternative embodiments, performing the action further includes responsive to re-establishment with the first network node, transmitting the report to the first network node.

Various operations from the flow chart of FIG. 14 may be optional with respect to some embodiments of communication devices and related methods.

FIG. 15 illustrates an example of operations performed by a first network node in a communications network that includes a second network node. The first network node and the second network node can provide dual connectivity to a communication device.

At block 1510, the operations include determining a failure has occurred during transmission of a report from the communication device to a second network node. In some embodiments, the report includes at least one of: a quality of experience, QoE, report; and a radio access network visible QoE, RVQoE, report.

In additional or alternative embodiments, the first network node is a master node, MN, the failure is a secondary cell group, SCG, failure, and the second network node is a secondary node, SN.

In additional or alternative embodiments, the first network node is a secondary node, SN, the failure is a master cell group, MCG, failure, and the second network node is a master node, MN.

At block 1520, the operations include communicating with the communication device. In some embodiments, the first network node communicates with the communication device in response to determining that the failure has occurred.

In additional or alternative embodiments, communicating with the communication device includes transmitting a message to the communication device requesting that the communication device transmit the report to the first network node.

In additional or alternative embodiments, communicating with the communication device comprises receiving a message from the communication device including the report.

Various operations from the flow chart of FIG. 15 may be optional with respect to some embodiments of RAN nodes and related methods.

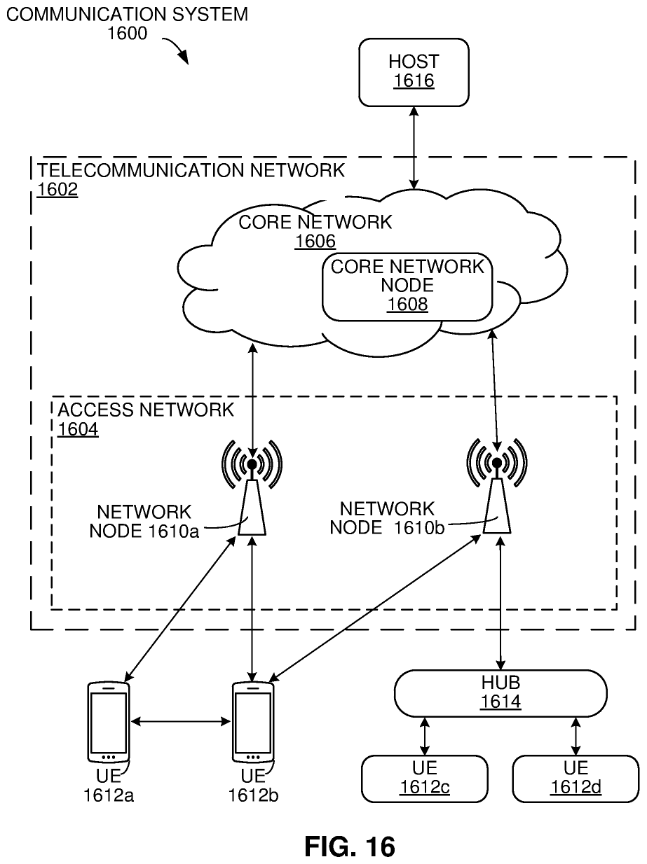

FIG. 16 shows an example of a communication system 1600 in accordance with some embodiments.

Herin the terms “or” and “and/or” are sometimes you interchangeably.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3rd Generation Partnership Project (3GPP) access node or non-3GPP access point. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub-that is, a hub whose primary function is to route communications to/from the UEs from/to the network node 1610b. In other embodiments, the hub 1614 may be a non-dedicated hub-that is, a device which is capable of operating to route communications between the UEs and network node 1610b, but which is additionally capable of operating as a communication start and/or end point for certain data channels.

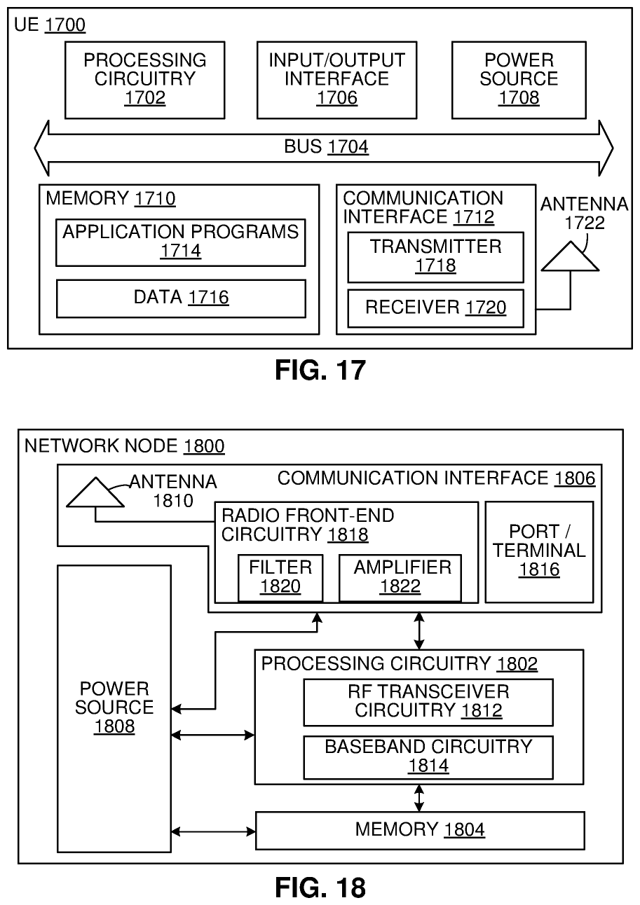

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

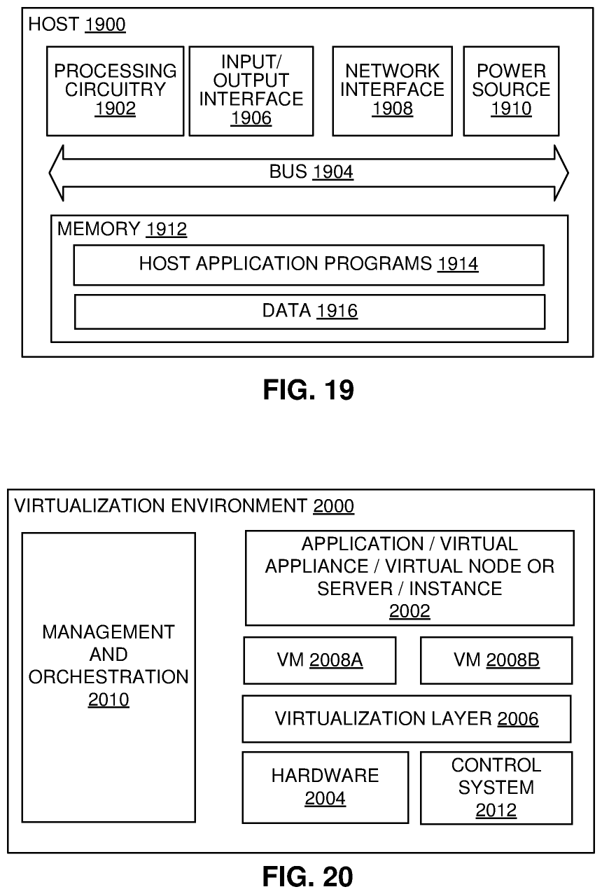

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top (OTT) services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

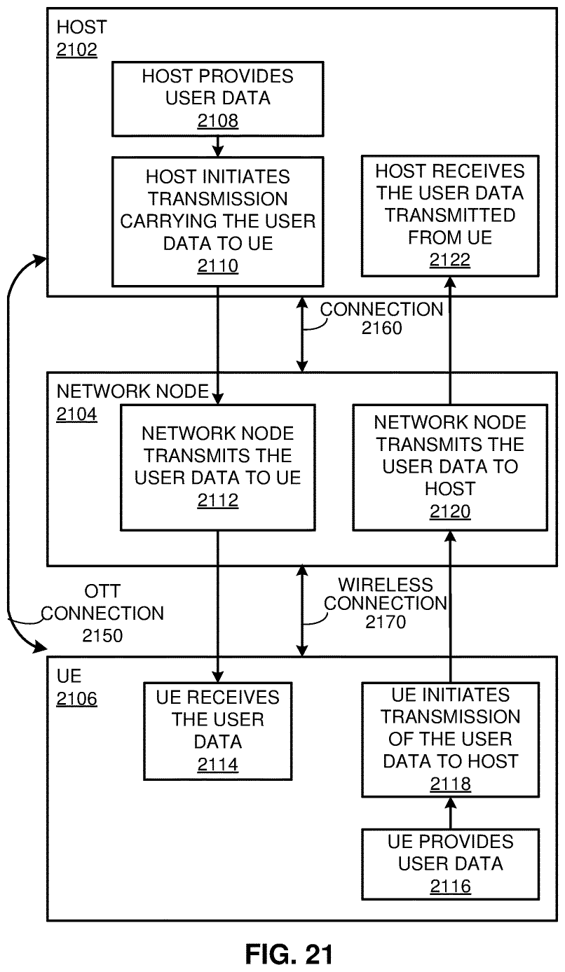

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, the teachings of these embodiments may improve data rate and/or latency and thereby provide benefits such as reduced user waiting, better responsiveness, and improved user experience.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc. ; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.
Embodiment 1. A method of operating a communication device in a communications network that includes a first network node and a second network node providing dual connectivity to the communication device, the method comprising:
determining (1410) a failure has occurred during transmission of a report to the first network node; and
responsive to determining that the failure has occurred, performing (1420) an action associated with the report.
Embodiment 2. The method of Embodiment 1, wherein performing the action comprises:
transmitting the report to the second network node.
Embodiment 3. The method of Embodiment 2, wherein transmitting the report to the second network node comprises:
receiving a message from the second network node, the message including a request for the report; and
responsive to receiving the message, transmitting the report to the second network node.
Embodiment 4. The method of Embodiment 3, wherein the message is a second message,
wherein transmitting the report to the second network node further comprises:
transmitting a first message to the second network node, the first message requesting instructions on how to handle the report.
Embodiment 5. The method of any of Embodiments 1-4, wherein performing the action comprises:
subsequent to determining the failure has occurred, initiating a timer.
Embodiment 6. The method of any of Embodiments 1-5, wherein performing the action comprises storing the report and/or an indication of the failure in a local memory.
Embodiment 7. The method of Embodiment 6, wherein performing the action further comprises:
responsive to expiration of the timer, deleting the report and/or the indication of the failure from the local memory.
Embodiment 8. The method of any of Embodiments 6-7, wherein storing the report and/or the indication of the failure in the local memory comprises:
determining that a communication failure has occurred with the second network node; and
responsive to determining that the communication failure has occurred with the second network node, storing the report and/or the indication of the failure in the local memory.
Embodiment 9. The method of any of Embodiments 1-8, wherein performing the action further comprises:
reconfiguring the communication device with another signaling radio bearer.
Embodiment 10. The method of any of Embodiments 1-9, wherein performing the action further comprises:
responsive to re-establishment with the first network node, transmitting the report to the first network node.
Embodiment 11. The method of any of Embodiments 1-10, wherein the report comprises at least one of:
a quality of experience, QoE, report; and
a radio access network visible QoE, RVQoE, report.
Embodiment 12. The method of any of Embodiments 1-11, wherein the first network node is a master node, MN,
wherein the failure is a master cell group, MCG, failure, and
wherein the second network node is a secondary node, SN.
Embodiment 13. The method of any of Embodiments 1-11, wherein the first network node is a secondary node, SN,
wherein the failure is a secondary cell group, SCG, failure, and
wherein the second network node is a master node, MN.
Embodiment 14. A method of operating a first network node in a communications network that includes a second network node, the first network node and the second network node providing dual connectivity to a communication device, the method comprising:
determining (1510) a failure has occurred during transmission of a report from the communication device to the second network node; and
responsive to determining that the failure has occurred, communicating (1520) with the communication device.
Embodiment 15. The method of Embodiment 14, wherein communicating with the communication device comprises transmitting a message to the communication device requesting that the communication device transmit the report to the first network node.
Embodiment 16. The method of any of Embodiments 14-15, wherein communicating with the communication device comprises receiving a message from the communication device including the report.
Embodiment 17. The method of any of Embodiments 14-16, wherein the report comprises at least one of:
a quality of experience, QoE, report; and
a radio access network visible QoE, RVQoE, report.
Embodiment 18. The method of any of Embodiments 1-17, wherein the first network node is a master node, MN,
wherein the failure is a secondary cell group, SCG, failure, and
wherein the second network node is a secondary node, SN.
Embodiment 19. The method of any of Embodiments 1-17, wherein the first network node is a secondary node, SN,
wherein the failure is a master cell group, MCG, failure, and
wherein the second network node is a master node, MN.
Embodiment 20. A communication device (1700), the communication device comprising:
processing circuitry (1702); and
memory (1710) coupled to the processing circuitry and having instructions stored therein that are executable by the communication device to cause the network node to perform operations comprising any of the operations of Embodiments 1-13.
Embodiment 21. A computer program comprising program code to be executed by processing circuitry (1702) of a communication device (1700), whereby execution of the program code causes the communication device to perform operations comprising any operations of Embodiments 1-13.
Embodiment 22. A computer program product comprising a non-transitory storage medium (1710) including program code to be executed by processing circuitry (1702) of a communication device (1700), whereby execution of the program code causes the communication device to perform operations comprising any operations of Embodiments 1-13.
Embodiment 23. A non-transitory computer-readable medium having instructions stored therein that are executable by processing circuitry (1702) of a communication device (1700) configured to perform operations comprising any of the operations of Embodiments 1-13.
Embodiment 24. A network node (1800), the network node comprising:
processing circuitry (1802); and
memory (1804) coupled to the processing circuitry and having instructions stored therein that are executable by the processing circuitry to cause the network node to perform operations comprising any of the operations of Embodiments 14-19.
Embodiment 25. A computer program comprising program code to be executed by processing circuitry (1802) of a network node (1800), whereby execution of the program code causes the network node to perform operations comprising any operations of Embodiments 14-19.
Embodiment 26. A computer program product comprising a non-transitory storage medium (1804) including program code to be executed by processing circuitry (1802) of a network node (1800), whereby execution of the program code causes the network node to perform operations comprising any operations of Embodiments 14-19.
Embodiment 27. A non-transitory computer-readable medium having instructions stored therein that are executable by processing circuitry (1802) of a network node (1800) configured to perform operations comprising any of the operations of Embodiments 14-19.
Embodiment 28. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   determining (1510) a failure has occurred during transmission of a report from the communication device to the second network node; and
   responsive to determining that the failure has occurred, communicating (1520) with the communication device.
Embodiment 29. The host of the previous embodiment, wherein:
the processing circuitry of the host is configured to execute a host application that provides the user data; and
the UE comprises processing circuitry configured to execute a client application associated with the host application to receive the transmission of user data from the host.
Embodiment 30. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
   determining (1510) a failure has occurred during transmission of a report from the communication device to the second network node; and
   responsive to determining that the failure has occurred, communicating (1520) with the communication device.
Embodiment 31. The method of the previous embodiment, further comprising, at the network node, transmitting the user data provided by the host for the UE.
Embodiment 32. The method of any of the previous 2 embodiments, wherein the user data is provided at the host by executing a host application that interacts with a client application executing on the UE, the client application being associated with the host application.
Embodiment 33. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   determining (1510) a failure has occurred during transmission of a report from the communication device to the second network node; and
   responsive to determining that the failure has occurred, communicating (1520) with the communication device.
Embodiment 34. The communication system of the previous embodiment, further comprising:
the network node; and/or
the user equipment.
Embodiment 35. The communication system of the previous 2 embodiments, wherein:
the processing circuitry of the host is configured to execute a host application, thereby providing the user data; and
the host application is configured to interact with a client application executing on the UE, the client application being associated with the host application.
Embodiment 36. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
   determining (1510) a failure has occurred during transmission of a report from the communication device to the second network node; and
   responsive to determining that the failure has occurred, communicating (1520) with the communication device.
Embodiment 37. The host of the previous 2 embodiments, wherein:
the processing circuitry of the host is configured to execute a host application, thereby providing the user data; and
the host application is configured to interact with a client application executing on the UE, the client application being associated with the host application.
Embodiment 38. The host of the any of the previous 2 embodiments, wherein the initiating receipt of the user data comprises requesting the user data.
Embodiment 39. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   determining (1510) a failure has occurred during transmission of a report from the communication device to the second network node; and
   responsive to determining that the failure has occurred, communicating (1520) with the communication device.
Embodiment 40. The method of the previous embodiment, further comprising at the network node, transmitting the received user data to the host.
Embodiment 41. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   determining (1410) a failure has occurred during transmission of a report to the first network node; and
   responsive to determining that the failure has occurred, performing (1420) an action associated with the report.
Embodiment 42. The host of the previous embodiment, wherein the cellular network further includes a network node configured to communicate with the UE to transmit the user data to the UE from the host.
Embodiment 43. The host of the previous 2 embodiments, wherein:
the processing circuitry of the host is configured to execute a host application, thereby providing the user data; and
the host application is configured to interact with a client application executing on the UE, the client application being associated with the host application.
Embodiment 44. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
   determining (1410) a failure has occurred during transmission of a report to the first network node; and
   responsive to determining that the failure has occurred, performing (1420) an action associated with the report.
Embodiment 45. The method of the previous embodiment, further comprising:
at the host, executing a host application associated with a client application executing on the UE to receive the user data from the UE.
Embodiment 46. The method of the previous embodiment, further comprising:
at the host, transmitting input data to the client application executing on the UE, the input data being provided by executing the host application,
wherein the user data is provided by the client application in response to the input data from the host application.
Embodiment 47. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
   determining (1410) a failure has occurred during transmission of a report to the first network node; and
   responsive to determining that the failure has occurred, performing (1420) an action associated with the report.
Embodiment 48. The host of the previous embodiment, wherein the cellular network further includes a network node configured to communicate with the UE to transmit the user data from the UE to the host.
Embodiment 49. The host of the previous 2 embodiments, wherein:
the processing circuitry of the host is configured to execute a host application, thereby providing the user data; and
the host application is configured to interact with a client application executing on the UE, the client application being associated with the host application.
Embodiment 50. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
   determining (1410) a failure has occurred during transmission of a report to the first network node; and
   responsive to determining that the failure has occurred, performing (1420) an action associated with the report.
Embodiment 51. The method of the previous embodiment, further comprising:
at the host, executing a host application associated with a client application executing on the UE to receive the user data from the UE.
Embodiment 52. The method of the previous embodiments, further comprising:
at the host, transmitting input data to the client application executing on the UE, the input data being provided by executing the host application,
wherein the user data is provided by the client application in response to the input data from the host application.

1. A method of operating a communication device in a communications network that includes a first network node and a second network node providing dual connectivity to the communication device, the method comprising:
determining a failure has occurred during transmission of a report to the first network node, the report including a quality of experience, QoE, report and/or a radio access network visible QoE, RVQoE, report;
responsive to determining that the failure has occurred, suspending transmission of the report to the first network node; and
responsive to determining that the failure has occurred, performing an action associated with the report.

2. The method of claim 1, wherein performing the action comprises:
transmitting the report to the second network node.

3. The method of claim 2, wherein transmitting the report to the second network node comprises:
receiving a message from the second network node, the message including a request for the report; and
responsive to receiving the message, transmitting the report to the second network node.

4. The method of claim 3, wherein the message is a second message,
wherein transmitting the report to the second network node further comprises:
transmitting a first message to the second network node, the first message requesting instructions on how to handle the report.

5. The method of claim 1, wherein performing the action comprises:
subsequent to determining the failure has occurred, initiating a timer.

6. The method of claim 1, wherein performing the action comprises storing the report and/or an indication of the failure in a local memory.

7. The method of claim 6, wherein performing the action further comprises:
responsive to expiration of the timer, deleting the report and/or the indication of the failure from the local memory.

8. The method of claim 6, wherein storing the report and/or the indication of the failure in the local memory comprises:
determining that a communication failure has occurred with the second network node; and
responsive to determining that the communication failure has occurred with the second network node, storing the report and/or the indication of the failure in the local memory.

9. The method of claim 1, wherein performing the action further comprises:
reconfiguring the communication device with another signaling radio bearer.

10. The method of claim 1, wherein performing the action further comprises:
responsive to re-establishment with the first network node, transmitting the report to the first network node.

11. The method of claim 1, wherein the first network node is a secondary node, SN,
wherein the failure is a secondary cell group, SCG, failure, and
wherein the second network node is a master node, MN.

12. The method of claim 1, wherein the first network node is a master node, MN,
wherein the failure is a master cell group, MCG, failure, and
wherein the second network node is a secondary node, SN.

13. A method of operating a first network node in a communications network that includes a second network node, the first network node and the second network node providing dual connectivity to a communication device, the method comprising:
determining a failure has occurred during transmission of a report from the communication device to the second network node, the report including a quality of experience, QoE, report and/or a radio access network visible QoE, RVQoE, report; and
responsive to determining that the failure has occurred, communicating with the communication device.

14. The method of claim 13, wherein communicating with the communication device comprises transmitting a message to the communication device requesting that the communication device transmit the report to the first network node.

15. The method of claim 13, wherein communicating with the communication device comprises receiving a message from the communication device including the report.

16. The method of claim 13, wherein the first network node is a master node, MN,
wherein the failure is a secondary cell group, SCG, failure, and
wherein the second network node is a secondary node, SN.

17-23. (canceled)

24. A communication device, the communication device comprising:
processing circuitry and
memory coupled to the processing circuitry and having instructions stored therein that are executable by the communication device to cause the network node to perform operations comprising:
determining a failure has occurred during transmission of a report to the first network node, the report including a quality of experience, QoE, report and/or a radio access network visible QoE, RVQoE, report;
responsive to determining that the failure has occurred, suspending transmission of the report to the first network node; and
responsive to determining that the failure has occurred, performing an action associated with the report.

25. The communication device of claim 24, the operations further comprising a method of operating a communication device in a communications network that includes a first network node and a second network node providing dual connectivity to the communication device, the method comprising:
determining a failure has occurred during transmission of a report to the first network node, the report including a quality of experience, QoE, report and/or a radio access network visible QoE, RVQoE, report;
responsive to determining that the failure has occurred, suspending transmission of the report to the first network node; and
responsive to determining that the failure has occurred, performing an action associated with the report,
wherein performing the action comprises transmitting the report to the second network node.

26-31. (canceled)

32. A network node, the network node comprising:
processing circuitry; and
memory coupled to the processing circuitry and having instructions stored therein that are executable by the processing circuitry to cause the network node to perform operations comprising:
determining a failure has occurred during transmission of a report from the communication device to the second network node, the report including a quality of experience, QoE, report and/or a radio access network visible QoE, RVQoE, report; and
responsive to determining that the failure has occurred, communicating with the communication device.

33. The network node of claim 32, the operations further comprising a method of operating a first network node in a communications network that includes a second network node, the first network node and the second network node providing dual connectivity to a communication device, the method comprising:
determining a failure has occurred during transmission of a report from the communication device to the second network node, the report including a quality of experience, QoE, report and/or a radio access network visible QoE, RVQoE, report; and
responsive to determining that the failure has occurred, communicating with the communication device,
wherein communicating with the communication device comprises transmitting a message to the communication device requesting that the communication device transmit the report to the first network node.
